(19) United States
(12) Patent Application Publication
(10) Pub. No.: US 2013/0120880 A1
(43) Pub. Date: May 16, 2013

(54) ELECTROSTATIC DISCHARGE PROTECTION CIRCUIT AND ELECTRONIC DEVICE

(71) Applicant: Kuo-Chih KUO, Tu-Cheng (TW)

(72) Inventor: Kuo-Chih KUO, Tu-Cheng (TW)

(73) Assignee: HON HAI PRECISION INDUSTRY CO., LTD., Tu-Cheng (TW)

(21) Appl. No.: 13/591,384

(22) Filed: Aug. 22, 2012

(30) Foreign Application Priority Data
Nov. 11, 2011 (TW) 100141332

(51) Int. Cl. H02H 7/04

(52) U.S. Cl. 361/18

(57) ABSTRACT

An electronic device includes a power supply, a load, a voltage conversion unit, a feedback unit, and an electrostatic discharge (ESD) protection circuit. The power supply provides an input voltage. The voltage conversion unit converts the input voltage to an output voltage which is supplied to the load. The voltage conversion unit includes a feedback pin and an output pin for outputting the output voltage. The feedback unit is connected to the output pin and the feedback pin for sampling the output voltage to generate a feedback signal. The voltage conversion unit receives the feedback signal through the feedback pin and adjusts the output voltage according to the feedback signal. The ESD protection circuit is connected to the feedback pin and is used for eliminating an ESD surge current flowing through the feedback pin.

### BACKGROUND

1. Technical Field

The disclosed embodiments relate to an electrostatic discharge (ESD) protection circuit and an electronic device using the same.

2. Description of Related Art

Voltage conversion circuits convert an input voltage to an output voltage. In order to maintain a stable output voltage, a feedback circuit is connected to a feedback pin of the voltage conversion circuit. The feedback circuit samples the output voltage and generates a feedback signal. The voltage conversion circuit adjusts the output voltage according to the feedback signal, so that the output voltage can be stable.

However, an ESD event may occur at the feedback pin of the voltage conversion circuit, causing an ESD surge current in the feedback pin, which may damage the voltage conversion circuit.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout four views.

FIG. 1 is a block diagram of an electronic device in accordance with an embodiment, the electronic device includes an ESD protection circuit.

FIG. 2 is a circuit diagram of the ESD protection circuit of FIG. 1 in accordance with a first embodiment.

FIG. 3 is a circuit diagram of the ESD protection circuit of FIG. 1 in accordance with a second embodiment.

FIG. 4 is a circuit diagram of the ESD protection circuit of FIG. 1 in accordance with a third embodiment.

### DETAILED DESCRIPTION

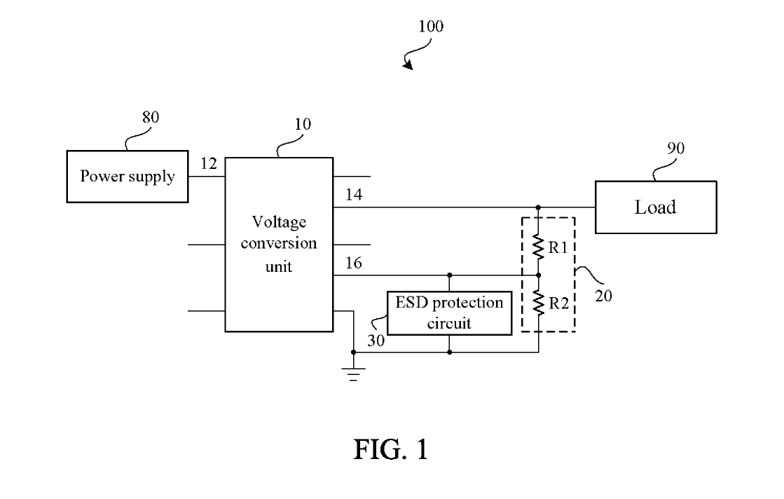

Referring to FIG. 1, an electronic device 100 includes a power supply 80, voltage conversion unit 10, a feedback unit 20, an ESD protection circuit 30, and a load 90. The power supply 80 is used for providing an input voltage. The voltage conversion unit 10 includes an input pin 12, an output pin 14, and a feedback pin 16. The input pin 12 receives the input voltage. The voltage conversion unit 10 is used for converting the input voltage to an output voltage. The output pin 14 supplies the output voltage to the load 90, the output voltage is used for powering the load 90. In this embodiment, the voltage conversion unit 10 is a DC to DC voltage conversion unit.

The feedback unit 20 is connected to the output pin 14 and the feedback pin 16 for sampling the output voltage to generate a feedback signal. In detail, the feedback unit 20 includes a first resistor R1 and a second resistor R2. One end of the first resistor R1 is connected to the output pin 14, and the other end of the first resistor R1 is grounded through the second resistor R2. The feedback pin 16 is connected between the first resistor R1 and the second resistor R2. The feedback pin 16 receives the feedback signal, and the voltage conversion unit 10 adjusts the output voltage according to the feedback signal, to maintain a stable output voltage.

The ESD protection circuit 30 is connected to the feedback pin 16 and is used for eliminating an ESD surge current flowing through the feedback pin 16.

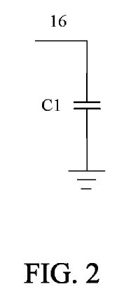

Referring to FIG. 2, in a first embodiment, the ESD protection unit 30 includes a capacitor C1. One end of the capacitor C1 is connected to the feedback pin 16, and the other end of the capacitor C1 is grounded. In this embodiment, the capacitance of the capacitor C1 is in a range from 100 pF to 1000 pF.

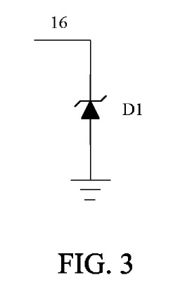

Referring to FIG. 3, in a second embodiment, the ESD protection unit 30 includes a zener diode D1. A cathode of the zener diode D1 is connected to the feedback pin 16, and an anode of the zener diode D1 is grounded.

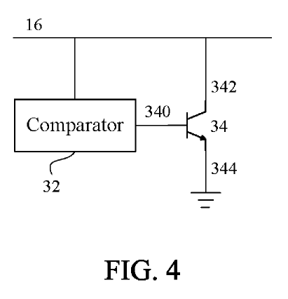

Referring to FIG. 4, in a third embodiment, the ESD protection unit 30 includes a comparator 32 and a transistor 34. The transistor 34 includes a control electrode 340, a first electrode 342, and second electrode 344. The comparator 32 is connected to the feedback pin 16 and the control electrode 340, the first electrode 342 is connected to the feedback pin 16, and the second electrode 344 is grounded. The comparator 32 is used for comparing a magnitude of a signal to the feedback pin 16 with a threshold value and generating a control signal when the magnitude of the signal is larger than the threshold value. In response to receiving the control signal, the transistor 34 is turned on and eliminates ESD surge current flowing through the feedback pin 16. Therefore, the feedback pin 16 is protected against ESD.

In one embodiment, the transistor 34 is an n-type metal oxide semiconductor filed effect transistor (NMOSFET), the control electrode 340 is a gate electrode of the NMOSFET, the first electrode 342 is a drain electrode of the NMOSFET, the second electrode 344 is a source electrode of the NMOSFET.

In the other embodiment, the transistor 34 is an npn transistor. The control electrode 340 is a base electrode of the npn transistor, the first electrode 342 is a collector electrode of the npn transistor, and the second electrode 344 is an emitter electrode of the npn transistor.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electrostatic discharge (ESD) protection circuit for protecting a voltage conversion unit, the voltage conversion unit configured for converting an input voltage from a power supply to an output voltage which is supplied to a load and comprising a feedback pin for receiving a feedback signal generated by sampling the output voltage; the voltage conversion unit further configured for adjusting the output voltage according to the feedback signal; wherein the ESD protection circuit is connected to the feedback pin, and is used for eliminating an ESD surge current flowing through the feedback pin.

2. The ESD protection circuit of claim 1, wherein the ESD protection unit comprises a comparator and a transistor, the transistor comprises a control electrode, a first electrode, and second electrode, the comparator is connected to the feedback pin and the control electrode, the first electrode is connected to the feedback pin, the second electrode is grounded; the comparator is used for comparing a magnitude of a signal flowing through the feedback pin with a threshold value and generating a control signal when the magnitude of the signal is larger than the threshold value, the transistor is turned on according to the control signal and eliminates the ESD surge current flowing through the feedback pin.

3. The ESD protection circuit of claim 2, wherein the transistor is an n-type metal oxide semiconductor filed effect transistor (NMOSFET), the control electrode is a gate electrode of the NMOSFET, the first electrode is a drain electrode of the NMOSFET, the second electrode is a source electrode of the NMOSFET.

4. The ESD protection circuit of claim 2, wherein the transistor is an npn transistor, the control electrode is a base electrode of the npn transistor, the first electrode is a collector electrode of the npn transistor, and the second electrode is an emitter electrode of the npn transistor.

5. The ESD protection circuit of claim 1, wherein the ESD protection unit comprises a capacitor, one end of the capacitor is connected to the feedback pin, and the other end of the capacitor is grounded.

6. The ESD protection circuit of claim 5, wherein the capacitance of the capacitor is in a range from 100 pF to 1000 pF.

7. The ESD protection circuit of claim 1, wherein the ESD protection unit comprises a zener diode, a cathode of the zener diode is connected to the feedback pin, and an anode of the zener diode is grounded.

8. An electronic device, comprising:
a power supply for providing an input voltage;
a load;
a voltage conversion unit for converting the input voltage to an output voltage which is supplied to the load, the voltage conversion unit comprising a feedback pin and an output pin for outputting the output voltage;
a feedback unit connected to the output pin and the feedback pin for sampling the output voltage to generate a feedback signal; wherein the voltage conversion unit receives the feedback signal through the feedback pin and adjusts the output voltage according to the feedback signal; and
an electrostatic discharge (ESD) protection circuit connected to the feedback pin and used for eliminating an ESD surge current flowing through the feedback pin.

9. The electronic device of claim 8, wherein the ESD protection unit comprises a capacitor, one end of the capacitor is connected to the feedback pin, and the other end of the capacitor is grounded.

10. The electronic device of claim 8, wherein the capacitance of the capacitor is in a range from 100 pF to 1000 pF.

11. The electronic device of claim 8, wherein the ESD protection unit comprises a zener diode, a cathode of the zener diode is connected to the feedback pin, and an anode of the zener diode is grounded.

12. The electronic device of claim 8, wherein the ESD protection unit comprises a comparator and a transistor, the transistor comprises a control electrode, a first electrode, and second electrode, the comparator is connected to the feedback pin and the control electrode, the first electrode is connected to the feedback pin, the second electrode is grounded; the comparator is used for comparing a magnitude of a signal flowing through the feedback pin with a threshold value and generating a control signal when the magnitude of the signal is larger than the threshold value, the transistor is turned on according to the control signal and eliminates the ESD surge current flowing through the feedback pin.

13. The electronic device of claim 12, wherein the transistor is an n-type metal oxide semiconductor filed effect transistor (NMOSFET), the control electrode is a gate electrode of the NMOSFET, the first electrode is a drain electrode of the NMOSFET, and the second electrode is a source electrode of the NMOSFET.

14. The electronic device of claim 12, wherein the transistor is an npn transistor, the control electrode is a base electrode of the npn transistor, the first electrode is a collector electrode of the npn transistor, and the second electrode is an emitter electrode of the npn transistor.

15. The electronic device of claim 8, wherein the feedback unit comprises a first resistor and a second resistor, one end of the first resistor is connected to the output pin, the other end of the first resistor is grounded through the second resistor; the feedback pin is connected between the first resistor and the second resistor.

16. The electronic device of claim 8, wherein the voltage conversion unit is a DC to DC voltage conversion unit.
